(19) United States
(12) Patent Application Publication
(10) Pub. No.: US 2010/0072006 A1
(43) Pub. Date: Mar. 25, 2010

(54) Brake Caliper Bracket That Can Be Screwed to the Axle Flange of a Motor Vehicle

(75) Inventors: Aleksandar Pericevic, Muenchen (DE); Johann Baumgartner, Moosburg (DE); Steffen Geissler, Hallbergmoos (DE); Robert Trimpe, Wessling (DE)

Correspondence Address: CROWELL & MORING LLP;INTELLECTUAL PROPERTY GROUP, P.O. BOX 14300, WASHINGTON, DC, 20044-4300, US

(73) Assignee: KNORR-BREMSE Systeme fuer Nutzfahrzeuge GmbH, Muenchen (DE)

(21) Appl. No.: 12/561,758

(22) Filed: Sep. 17, 2009

Related U.S. Application Data
(63) Continuation of application No. PCT/EP2008/002185, filed on Mar. 19, 2008.

(30) Foreign Application Priority Data
Mar. 19, 2007 (DE) 10 2007 013 670.8

(51) Int. Cl. F16D 55/225

(52) U.S. Cl. 188/73.46

(57) ABSTRACT

A disc brake caliper bracket is provided that can be bolted to the axle flange of a motor vehicle, especially of a commercial vehicle. The bracket has throughbores through which connectors can be led for connection to the axle flange. The brake caliper bracket is configured such that the throughbores are located on a perforated concentric graduated circle of a connecting flange formed thereto.

### CROSS-REFERENCE TO RELATED APPLICATIONS

This application is a continuation of PCT International Application No. PCT/EP2008/002185, filed Mar. 19, 2008, which claims priority under 35 U.S.C. §119 to German Patent Application No. DE 10 2007 013 670.8, filed Mar. 19, 2007, the entire disclosures of which are herein expressly incorporated by reference.

### BACKGROUND AND SUMMARY OF THE INVENTION

The invention relates to a brake caliper bracket that can be bolted to an axle flange of a motor vehicle, especially a commercial or utility vehicle.

Wheel brakes of different types varying according to their intended use and sphere of operation are used in heavy commercial vehicles. Thus long-haul commercial vehicles, for example, are preferably fitted with air-operated disc brakes, whilst vehicles destined for use under poor road conditions are usually equipped with air-operated drum brakes. In addition, there are spheres of operation in which trucks are fitted with hydraulic disc brakes.

These different types of brakes, particularly the differences between disc and drum brakes, each require methods of attachment to the vehicle that are specific to the brake.

At least some of the fixing bolts used in attaching the brake caliper bracket of a disc brake, for example, will be subjected to shear stresses, since in the given space available it is not possible to transmit the effective braking forces solely by way of the frictional resistance between the axle flange and the adjoining brake caliper bracket.

Fixing bolts in the form of body-fit bolts are therefore sometimes used which, owing to the tight play in the through-hole, under load bear on the inner surface of the through-hole. These body-fit bolts, in principle, are suited to absorbing relatively large shear forces.

At the same time, the brake caliper bracket of a floating caliper disc brake, for example, has two mirror-symmetrical connecting flanges, one on either side, which are connected together by a tension strut. Both connecting flanges are provided with corresponding bolts and through-holes and require a specific hole pattern on the axle flange or on fastening parts connected thereto.

In a fixed-caliper disc brake, the brake caliper is fixed directly to the axle flange or equivalent vehicle parts, that is to say, the brake caliper bracket is part of the brake caliper.

The drum brake is provided with an anchor plate, through which the through-holes, arranged about a circle, are formed. The through-holes usually are arranged at the same angular interval in relation to one another.

While the brake caliper bracket of a disc brake under load is absolutely free to move within certain limits in the direction of rotation of the wheel, according to the play between the bolt and the through-hole, such “slipping” is inadmissible in the connection of the anchor plate to the axle flange in drum brakes, since this would lead to a displacement of the brake shoes relative to the brake drum friction surface and hence to a variation in and possible exhaustion of the clearance. The result would be severe grinding and overheating of the brake. For this reason, it is necessary in the case of drum brakes to hold the anchor plate immovably in position solely by frictional forces in the flange connection.

The axle flanges of a commercial vehicle are usually adapted to the particular fixing requirements of a drum brake, that is to say, they are provided with bolt sockets corresponding to the arrangement of the through-hole in the anchor plate of the drum brake, in respect both of the hole circle radius and of the angular intervals of the through-holes.

In order to be able to fit the vehicle with disc brakes, structural modifications have therefore hitherto been necessary in order to adapt the bolt sockets to the hole pattern of the brake caliper bracket. For this purpose, additional components such as intermediate flanges, adapters, or the like are fitted, which naturally entails a considerable production and assembly effort with resulting additional costs. Moreover, the additionally installed components lead to an increase in weight, which particularly in the area of the brakes, is counterproductive with regard to efforts aimed at saving weight.

The object of the invention is to develop a brake caliper bracket that can be fitted to the motor vehicle more easily and without additional components.

This object is achieved by a brake caliper bracket of a disc brake that can be bolted to an axle flange of a motor vehicle, in particular a commercial vehicle. The bracket has through-holes, through which connectors can be introduced for connection to the axle flange. The through-holes are arranged on a concentric partial circle of holes of a formed-on connecting flange. A brake caliper bracket embodied in this way affords considerable advantages over one according to the state of the art.

It is to be particularly emphasized that adapter parts or intermediate flanges can be entirely dispensed with, particularly where, as in an advantageous development of the invention, the radius of the partial hole circle is equal to the radius of the hole circle of a drum brake anchor plate that can be fitted to the axle flange and the angular intervals of the through-holes correspond to the angular intervals of through-holes introduced through the anchor plate on the hole circle of the anchor plate.

In principle, a choice is afforded between a disc brake and a drum brake without the need for additional structural measures in order to accomplish either brake. This includes conversion of the motor vehicle from drum to disc brakes. While dismantling the disc brake was hitherto often possible only with a considerable fitting effort, because the basic design of the vehicle was not adapted to its structural conditions and sometimes even necessitated complete removal of the wheel hub, changing the disc brake including the brake caliper bracket is now significantly easier. These advantages naturally lead to a reduction in costs both in manufacture and in fitting and removal of the brake.

A further advantage in addition to this is the reduction or savings in weight, which results from the absence of additional components and which leads, among other things, to a reduction in material consumption and hence to operating cost savings.

According to a further aspect of the invention, the connecting flange is to be provided with a recess concentric with the partial hole circle. The design of the connecting flange, which in the fitted position is therefore open at the bottom, allows easy assembly and dismantling of the brake without removing the wheel hub or other axle components.

In addition, the inventive design of the connecting flange makes the load-bearing ratios more favorable compared to a known brake caliper bracket, since the now central attachment area of the brake caliper bracket inevitably leads to a more rigid connection of the disc run-in side to the disc run-out side of the brake caliper bracket, all fastening bolts now being involved in absorbing the tangential forces supported on the disc run-out side, that is to say absorbing the generated braking torque.

Compared to the hitherto existing attachment of the brake caliper bracket to the axle flange, in which one of the fastening bolts on the run-out side forms a pivot bearing, about which the brake caliper bracket endeavors to rotate when the braking force is introduced and which is equipped with the body-fit bolt in order to limit the play, the distance to the point of application of the tangential force and hence a torque acting on the brake caliper bracket is smaller, so that normally only this bolt is subjected to shear stresses.

Further advantageous embodiments of the invention are described herein.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic side view of a drum brake according to the state of the art; and

FIG. 2 shows a likewise schematic side view of a brake caliper bracket according to the invention.

### DETAILED DESCRIPTION OF THE DRAWINGS

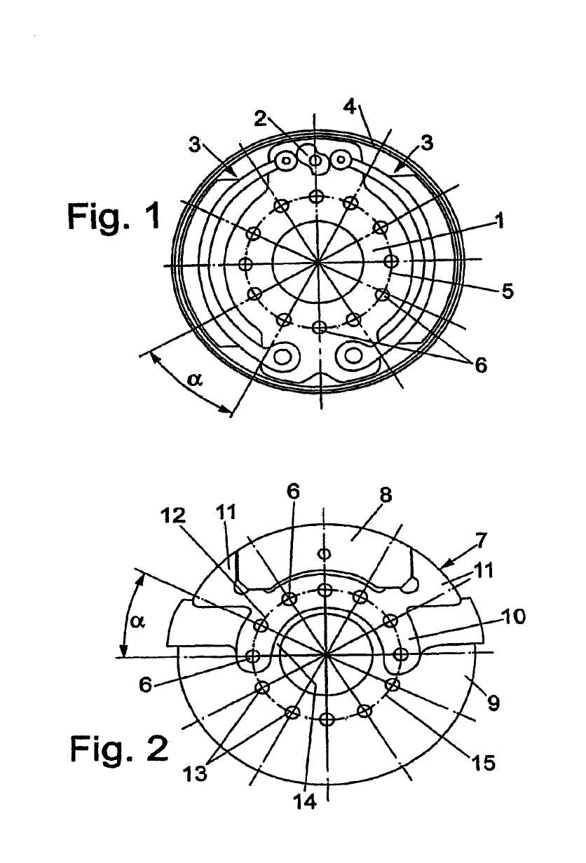

FIG. 1 represents a drum brake as an example of a brake according to the state of the art. The drum brake is provided with two brake shoes 3, which via an S-shaped cam 2 each can be expansively pressed against the inside wall of a drum 4.

For attaching the drum brake in the wheel area of a motor vehicle, preferably a commercial vehicle, the drum brake has an anchor plate 1 with a plurality of through-holes 6 arranged on a hole circle 5. Here, each through-hole 6 is arranged at the same angular intervals a relative to one another.

To illustrate an embodiment of the invention, FIG. 2 represents a brake caliper bracket 7 of a floating caliper disc brake, which brake 7 includes two brake caliper bracket horns 11, which laterally define a brake pad well, into which a brake pad 8 is inserted.

According to the embodiment of the invention, the brake caliper bracket 11 includes a connecting flange 10, into which are formed multiple through-holes 6, which are arranged on a partial hole circle 12 at the same angular interval a to one another. Towards the center, the connecting flange 10 is defined by the contour of a concentric convexity 14, resulting in a semi-circular or horseshoe-shaped configuration of the connecting flange 10.

In their positioning, the through-holes 6 are congruent with the connections 13 of a vehicle axle flange 9, which are distributed over a hole circle 15. These connections 13 possibly consist of tapped holes, through-holes, threaded pins or the like.

The radii of the hole circle 5 in the anchor plate 1 of the drum brake and the hole circle 15 in the axle flange 9, together with that of the partial hole circle 12 in the brake caliper bracket 7 are equal, as are the angular intervals a of the through-holes 6 in the anchor plate and the connecting flange and the connections 13, so that it is readily possible to fit either the drum brake or the brake caliper bracket 7 and hence to it a disc brake.

### TABLE OF REFERENCE NUMERALS

1 anchor plate
2 S-shaped cam
3 brake shoe
4 drum
5 hole circle
6 through-hole
7 brake caliper bracket
8 brake pad
9 axle flange
10 connecting flange
11 brake caliper bracket horn
12 partial hole circle
13 connections
14 convexity
15 hole circle

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A component of a disc brake boltable to an axle flange of a commercial motor vehicle, comprising:
a brake caliper bracket of the disc brake, the brake caliper bracket including a connecting flange; and
wherein through-holes are arranged about a concentric partial circle of the connecting flange, said through-holes being operatively arranged about the partial circle on the connecting flange such that connectors are introduceable there through for connecting the brake caliper bracket to the axle flange.

2. The component according to claim 1, wherein the connecting flange comprises a concentric inner convexity.

3. The component according to claim 1, wherein the connecting flange has a semi-circular or horseshoe flange shape.

4. The component according to claim 2, wherein the connecting flange has a semi-circular or horseshoe flange shape.

5. The component according to claim 1, wherein the connecting flange has a mirror-symmetrical configuration with respect to a vertical plane through a longitudinal axis of an axle of the vehicle.

6. The component according to claim 1, wherein a radius of the partial circle of holes of the connecting flange is formed to equal a radius of a hole circle on which connections of the axle flange are arranged.

7. The component according to claim 2, wherein a radius of the partial circle of holes of the connecting flange is formed to equal a radius of a hole circle on which connections of the axle flange are arranged.

8. The component according to claim 3, wherein a radius of the partial circle of holes of the connecting flange is formed to equal a radius of a hole circle on which connections of the axle flange are arranged.

9. The component according to claim 1, wherein angular intervals of the through holes about the partial circle of the connecting flange correspond to angular intervals of the connections of the axle flange.

10. The component according to claim 6, wherein angular intervals of the through holes about the partial circle of the connecting flange correspond to angular intervals of the connections of the axle flange.

11. The component according to claim 7, wherein angular intervals of the through holes about the partial circle of the connecting flange correspond to angular intervals of the connections of the axle flange.

12. The component according to claim 1, wherein the brake caliper bracket is a separate component of a floating caliper disc brake.

13. The component according to claim 6, wherein the brake caliper bracket is a separate component of a floating caliper disc brake.

14. The component according to claim 9, wherein the brake caliper bracket is a separate component of a floating caliper disc brake.

15. The component according to claim 1, wherein the brake caliper bracket is an integral component of a fixed caliper disc brake.

16. The component according to claim 6, wherein the brake caliper bracket is an integral component of a fixed caliper disc brake.

17. The component according to claim 9, wherein the brake caliper bracket is an integral component of a fixed caliper disc brake.
